(19) United States
(12) Patent Application Publication
(10) Pub. No.: US 2024/0157331 A1
(43) Pub. Date: May 16, 2024

(54) OIL-SORBENT

(71) Applicant: KOREA INSTITUTE OF SCIENCE AND TECHNOLOGY, Seoul (KR)

(72) Inventors: Seong Jin KIM, Seoul (KR); CHAE YOUNG AHN, Seoul (KR); Myoung-Woon MOON, Seoul (KR); Sangyeob LEE, Hwaseong-si (KR)

(21) Appl. No.: 18/300,285

(22) Filed: Apr. 13, 2023

(30) Foreign Application Priority Data
Nov. 11, 2022 (KR) 10-2022-0150941

(51) Int. Cl. B01J 20/28; B01J 20/32

(52) U.S. Cl. CPC B01J 20/28045; B01J 20/28007; B01J 20/3236; B01J 20/3274; B01J 20/3295

(57) ABSTRACT

Provided is an oil-sorbent including a hydrophilic structure. The hydrophilic structure includes a plurality of macro pores. The macro pores have an average diameter of at least about 2 mm. An oil-sorbent includes a hydrophilic structure including a plurality of macro pores. The hydrophilic structure has an open-porous structure and has a porosity of at least 70%.

### CROSS-REFERENCE TO RELATED APPLICATIONS

This U.S. non-provisional patent application claims priority under 35 U.S.C. § 119 of Korean Patent Application No. 10-2022-0150941, filed on Nov. 11, 2022, the entire contents of which are hereby incorporated by reference.

### BACKGROUND

The present disclosure herein relates to an oil-sorbent.

Oil-sorbents refer to substances that are used to adsorb and recover spilled oil from rivers, oceans, etc. Currently, polypropylene is typically used as an oil-sorbent in cleanup work and industrial sites and is a hydrophobic material. When oil is adsorbed with an oil-sorbent made of polypropylene, the oil may not be reused because the oil is not separable from a sorbent. Therefore, the oil-sorbent, which has adsorbed oil, is classified as waste and incinerated.

In addition, carbon monoxide emitted when an oil-sorbent made of polypropylene is burnt is toxic gas and thus harmful to the human body. When crude oil is burnt, only highly volatile gas is burnt, and harmful substance remains as it is to cause environmental pollution. The oil-sorbent made of polypropylene becomes heavier after adsorbing oil and sinks under the water or are lost. The oil-sorbent made of polypropylene does not decompose in nature and may therefore cause secondary pollution.

Accordingly, it is required to develop an oil adsorbent that not only adsorbs oil within a short time due to having excellent oil adsorption capacity but also is eco-friendly.

### SUMMARY

The present disclosure provides a structure of an oil-sorbent having excellent abilities for oil adsorption and oil desorption.

An embodiment of the inventive concept provides an oil-sorbent including a hydrophilic structure, the hydrophilic structure includes a plurality of macro pores, and each of the macro pores has an average diameter of about 2 mm and more.

In an embodiment, a surface of the hydrophilic structure may have hydrophilicity.

In an embodiment, the hydrophilic structure may further include a hydrophilic nano-substructure provided on the surface.

In an embodiment, the hydrophilic structure may have a water contact angle of greater than about 0° and less than about 40°.

In an embodiment, the hydrophilic structure may include a hydrophobic structure containing the macro pores and hydrophilic nano-substructures on the hydrophobic structure.

In an embodiment, each of the hydrophilic nano-substructures may have a shape protruding from the surface of the hydrophobic structure, and the hydrophilic nano-substructures may be spaced apart from each other.

In an embodiment, the hydrophobic structure may include a first metal, and the hydrophilic nano-substructures may include an oxide of a second metal different from the first metal.

In an embodiment, the first metal may include aluminum, and the second metal oxide may include titanium dioxide.

In an embodiment, the hydrophilic structure may include a hydrophobic structure containing the macro pores and a hydrophilic coating layer on the hydrophobic structure.

In an embodiment, the hydrophilic coating layer may have a smaller thickness than the hydrophobic structure.

In an embodiment, the hydrophilic coating layer may include a dopamine substance.

In an embodiment, the hydrophilic coating layer may include at least one of polyvinyl alcohol (PVA), polyallylamine hydrochloride, or mixtures thereof

In an embodiment, the hydrophobic structure may include polyurethane foam.

In an embodiment, the hydrophilic structure may further include a floating body disposed therein.

In an embodiment, the floating body may include air or hydrophobic material.

In an embodiment of the inventive concept, an oil-sorbent includes a hydrophilic structure containing a plurality of macro pores, and the hydrophilic structure has an open-porous structure and a porosity of at least 70%.

In an embodiment, the macro pores may have an average diameter of about 2 mm to about 7 mm.

In an embodiment, the hydrophilic structure may include at least one of dopamine, titanium dioxide, polyvinyl alcohol (PVA), or polyallylamine hydrochloride.

In an embodiment, the hydrophilic structure may include a hydrophobic structure containing the macro pores and a hydrophilic coating layer covering a surface of the hydrophobic structure.

In an embodiment, the hydrophilic structure may further include hydrophilic nano-substructures between the hydrophobic structure and the hydrophilic coating layer.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept.

In the drawings:

FIG. 1 schematically illustrates an oil-sorbent according to an embodiment of the inventive concept;

FIG. 2 is an enlarged view illustrating a hydrophilic structure of an oil-sorbent according to an embodiment of the inventive concept;

FIG. 3 is an enlarged view of a cross-section taken along line I-I′ of FIG. 2;

FIG. 4A is an enlarged view of a cross-section taken along line I-I′ of FIG. 2;

FIG. 4B is an enlarged view of a cross-section taken along line I-I′ of FIG. 2;

FIG. 5 is a view of an oil-sorbent according to some embodiments;

FIG. 6A is an enlarged view corresponding to AA of FIG. 1;

FIG. 6B is an enlarged view corresponding to AA of FIG. 1;

FIG. 7 is a view illustrating a state in which an oil-sorbent according to the embodiment of the inventive concept adsorbs oil spilled on the sea;

FIG. 8 is an enlarged view corresponding to BB of FIG. 7;

FIG. 9 is a view illustrating a state in which the oil-sorbent according to the embodiment of the inventive concept has adsorbed oil;

FIG. 10 is an enlarged view corresponding to CC of FIG. 9;

FIG. 11 is a view illustrating a state in which oil is desorbed from the oil-sorbent according to the embodiment of the inventive concept;

FIG. 12 is an enlarged view illustrating a hydrophilic structure of an oil-sorbent according to some Comparative Examples;

FIG. 13 is a conceptual view illustrating a process in which an oil-sorbent according to some Comparative Examples adsorbs oil;

FIG. 14 is a conceptual view illustrating a process in which an oil-sorbent according to some Comparative Examples adsorbs oil;

FIG. 15 is a graph showing measurement results of a weight of oil per unit area, obtained after oil adsorption and desorption according to Examples and Comparative Examples, in which oil-sorbents have different materials and different pore sizes;

FIG. 16 is a graph showing measurement results of a weight of oil per unit area obtained after oil adsorption and desorption according to Examples, in which oil-sorbents have different thicknesses; and

FIG. 17 is a graph showing measurement results of a weight of oil per unit area obtained after oil adsorption and desorption according to Examples, in which oil-sorbents have different pore sizes.

### DETAILED DESCRIPTION

The accompanying drawings are included to provide a further understanding of configurations and effectiveness of the inventive concept and are incorporated in and constitute a part of this specification. The drawings illustrate embodiments of the inventive concept and, together with the description, serve to explain principles of the inventive concept. However, this is not intended to limit the inventive concept to an embodiment disclosed below, various forms may be applied, and various modifications may be made. However, the disclosure of the inventive concept is completed through the description of an embodiment. In addition, an embodiment of the inventive concept is provided to inform completely those skilled in the art of the scope of the inventive concept to which the present inventive concept belongs. In the accompanying drawings, the size of the components is illustrated as larger than an actual size for convenience of description, and the ratio of each component may be exaggerated or reduced.

Unless otherwise defined differently, all terms used herein have the same meaning as commonly understood by one of ordinary skill in the art to which the inventive concept belongs. Hereinafter, the inventive concept will be explained in detail through an embodiment of the inventive concept with reference to the accompanying drawings.

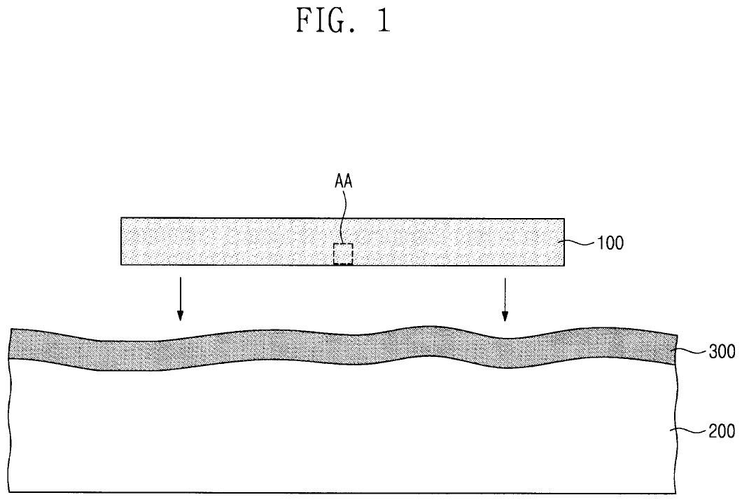

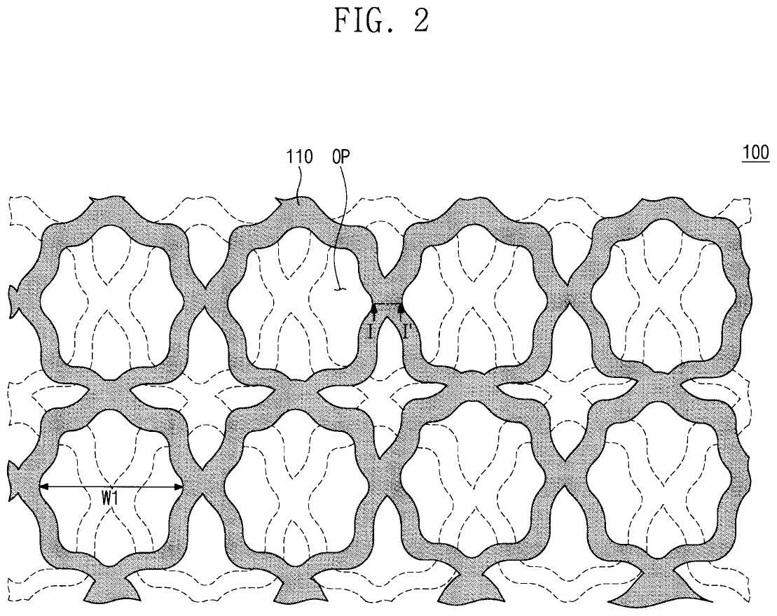

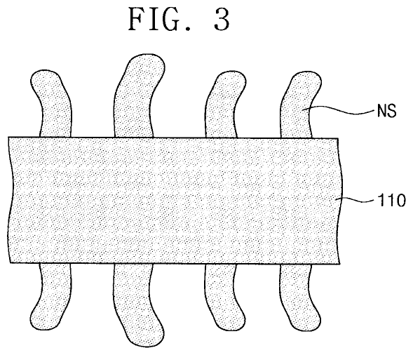

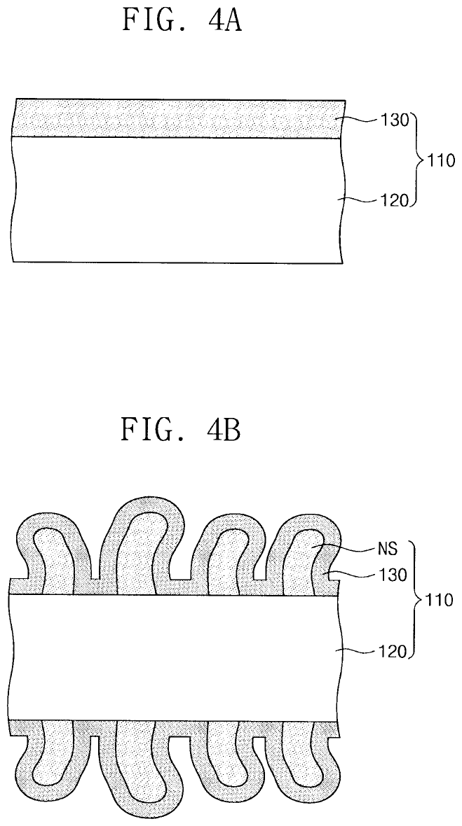

FIG. 1 schematically illustrates an oil-sorbent according to an embodiment of the inventive concept. FIG. 2 is an enlarged view illustrating a hydrophilic structure of an oil-sorbent according to an embodiment of the inventive concept. FIG. 3 is an enlarged view of a cross-section taken along line I-I′ in FIG. 2. FIG. 4A is an enlarged view of a cross-section taken along line I-I′ in FIG. 2. FIG. 4B is an enlarged view of a cross-section taken along line I-I′ in FIG. 2.

Referring to FIG. 1, an oil layer 300 may be placed on an oil separation layer 200. The oil separation layer 200 is a layer separated from the oil layer 300, and includes a material such as water as an example. The oil separation layer 200 may indicate a sea, an upper part of a river, a seacoast, etc. An oil-sorbent 100 may adsorb oil in the manner of being placed on the oil layer 300.

Referring to FIGS. 1 and 2, the oil-sorbent 100 may include a hydrophilic structure 110 containing a plurality of macro pores OP.

The macro pores OP may have an average diameter WI of several mm or more. The average diameter WI may be about 2 mm or more. For example, the average diameter WI may be about 2 nm to about 7 nm. The macro pores OP may be connected in a chain with each other. The hydrophilic structure 110 may have an open-cell structure or an open porous structure. The hydrophilic structure 110 may have a porosity of about 70% or more.

The surface of the hydrophilic structure 110 may have hydrophilicity. In this specification, having ‘hydrophilicity’ indicates having polarity, tending to adsorb water, and tending to be collected on the water.

In particular, a water contact angle between the surface of the hydrophilic structure 110 and water may be greater than about 0° and less than about 40°.

According to some embodiments, an entire material constituting the hydrophilic structure 110 may include a hydrophilic material. The hydrophilic material may include, for example, a hydrophilic polymer foam.

According to some embodiments, as illustrated in FIG. 3, the hydrophilic structure 110 may further include nano-substructures NS on a surface portion thereof. The nano-substructures NS may each have one or more shapes selected from the group consisting of nano hairs, nanofibers, nanopillars, and nanowires. The nano-substructure NS may have a shape protruding from the surface of the hydrophobic structure. According to some embodiments, the nano-substructures NS are spaced apart from each other. The nano-substructures NS may further increase the surface hydrophilicity of the hydrophilic structure 110.

According to some embodiments, as illustrated in FIG. 4, the hydrophilic structure 110 may include a hydrophobic structure 120 and a hydrophilic coating layer 130 on the hydrophobic structure 120. The hydrophobic structure 120 may include macro pores corresponding to the macro pores OP of the hydrophilic structure 110. The hydrophobic structure 120 may be, for example, a hydrophobic polymer foam. The hydrophilic coating layer 130 may include any one of dopamine or a hydrophilic polymer. The hydrophilic polymer may include, for example, at least any one of polyvinyl alcohol, polyallylamine hydrochloride, or mixtures thereof.

According to some embodiments, as shown in FIG. 4B, the hydrophilic structure 110 may include a hydrophobic structure 120, nano-substructures NS on the hydrophobic structure 120, and a hydrophilic coating layer 130 covering the hydrophobic structure 120 and the nano-substructures NS. According to some embodiments, the hydrophilic coating layer 130 may be omitted. As an example, the hydrophobic structure 120 may include a first metal, and the nano-substructures NS may include a second metal which is different from the first metal. The hydrophobic structure 120 may be an aluminum foam, and the nano-substructures NS may include titanium oxide (TiO₂). The hydrophilic coating layer 130 may include any one of dopamine or a hydrophilic polymer.

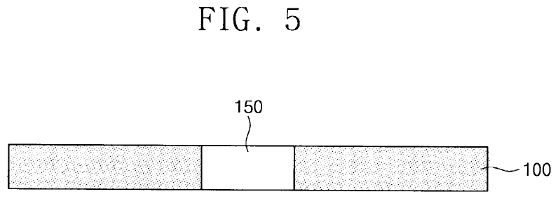

FIG. 5 is a view illustrating an oil-sorbent according to some embodiments.

Referring to FIG. 5, the oil-sorbent 100 may further include a floating body 150. The floating body 150 may prevent the oil-sorbent from sinking even when the oil-sorbent 100 adsorbs oil and thus increases in weight. The floating body 150 may include air or a hydrophobic material.

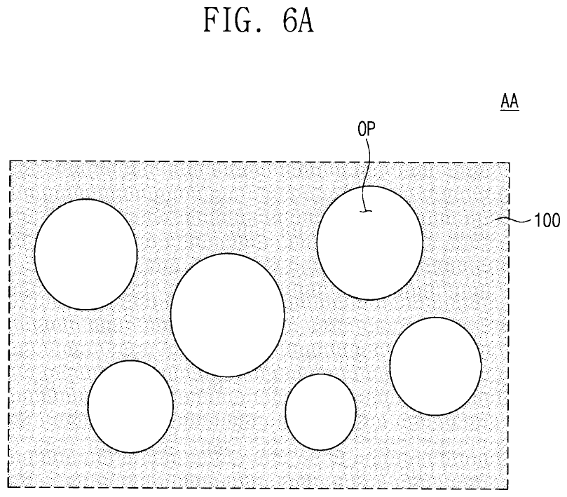

FIGS. 6A and 6B are enlarged views corresponding AA in FIG. 1.

In FIG. 1, before placing the oil-sorbent 100 on the oil layer 300, the oil-sorbent 100 may be soaked in water (for example, dipping). In this case, on the hydrophilic structure 110 in FIG. 6A, a water film 200C may be formed and left on the surface, as illustrated in FIG. 6B. Water may be contained in the macro pores OP. The water film 200C may fill a part of the macro pore OP.

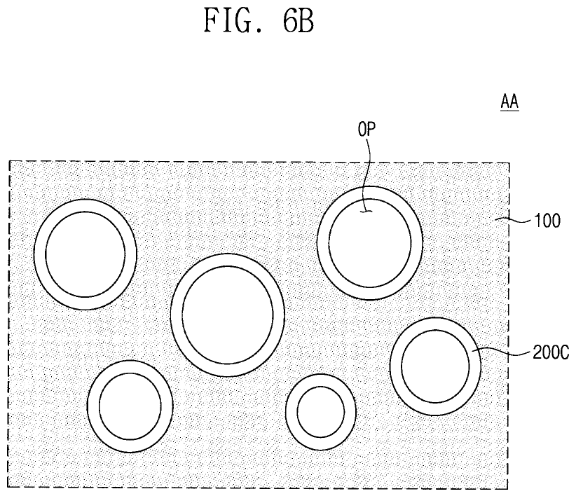

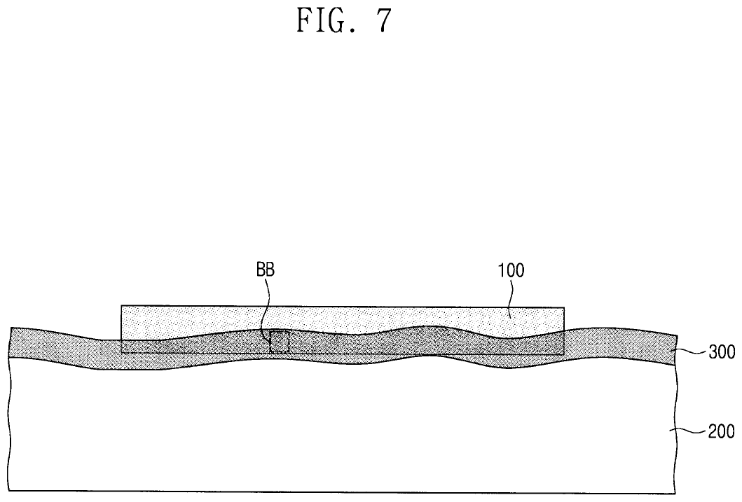

FIG. 7 is a view illustrating a state in which the oil-sorbent according to an embodiment of the inventive concept adsorbs oil spilled on the sea. FIG. 8 is an enlarged view corresponding to BB in FIG. 7.

Referring to FIGS. 7 and 8, an oil 300C in the oil layer 300 may permeate an unfilled space from the water film 200C of the macro pores OP. The water film 200C may cover a surface of the hydrophilic structure 110, and thus, when the oil 300C is introduced into macro pores OP, the oil may be prevented from strongly adhering to the hydrophilic structure 110 even when the oil 300C has a high viscosity.

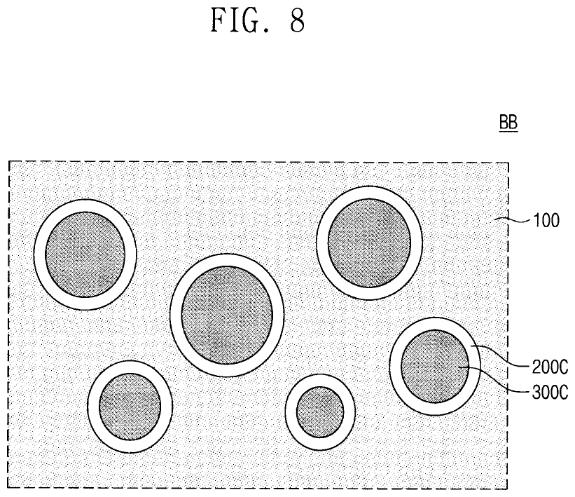

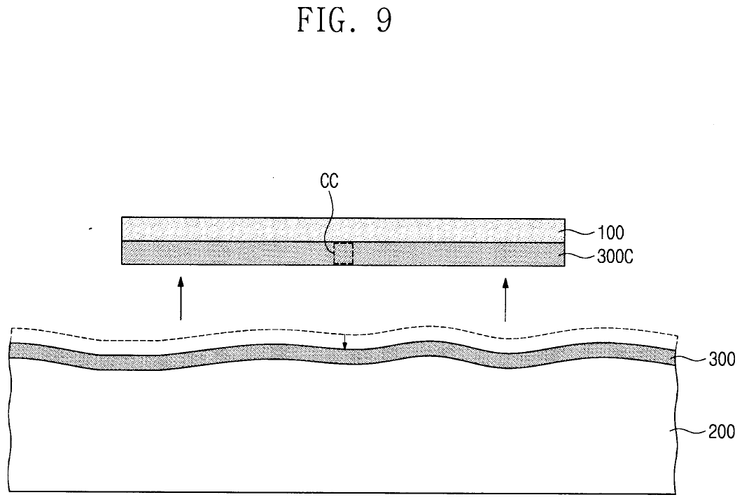

FIG. 9 is a view illustrating a state in which an oil-sorbent according to an embodiment of the inventive concept has adsorbed oil. FIG. 10 is an enlarged view corresponding to CC in FIG. 9.

Referring to FIGS. 9 and 10, the oil-sorbent 100 may adsorb the oil 300C. As a result, the thickness(amount) of the oil layer 300 may be decreased.

Even after the oil-sorbent 100 has recovered from the oil layer 300, the oil 300C may still remain in the macro pores OP. Due to the surface tension and viscosity of the oil 300C, the oil 300C may stick together.

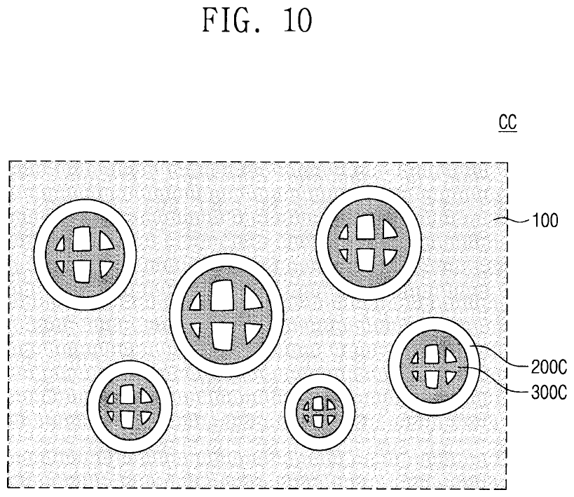

FIG. 11 is a view illustrating a state in which oil is desorbed from the oil-sorbent according to an embodiment of the inventive concept.

Referring to FIG. 11, the oil-sorbent 100 may be disposed in an oil separation tank 400. Water may be stored in the oil separation tank 400. In the oil separation tank 400, the oil 300C in the oil-sorbent 100 may be desorbed through strong vertical and/or horizontal vibrations and compression. In the desorption process, shear stress is applied between the oil 300C and the hydrophilic structure 110. In general, when the viscosity of the oil 300C is high, a large shear stress is required for desorption of the oil. According to the idea of the inventive concept, macro pores with a millimeter-level size may minimize the shear stress required during oil desorption even when the viscosity of the oil is high. As a result, as the oil 300C in the macro pore OP is desorbed from the oil-sorbent 100, the oil 300C and the oil-sorbent 100 may be reused.

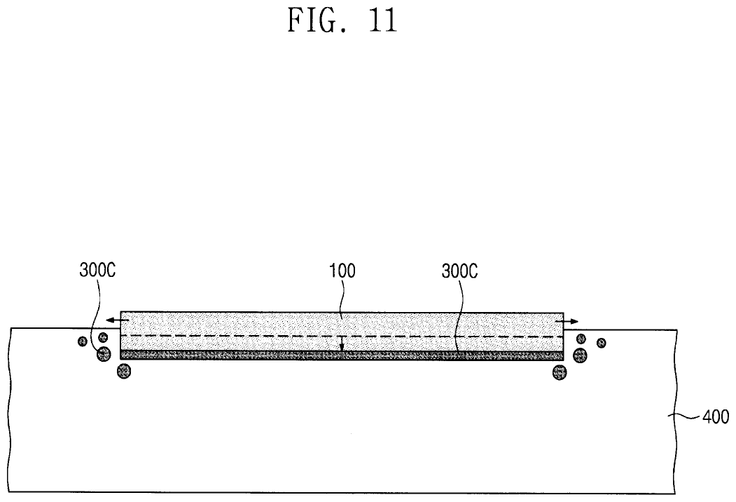

FIG. 12 is an enlarged view illustrating a hydrophilic structure of the oil-sorbent according to some Comparative Examples.

Referring to FIG. 12, an oil-sorbent 500 according to some Comparative Examples may include a hydrophilic structure 510 having a closed cell or closed pore structure. In this case, macro pores CP may not be connected in a chain with each other. When oil is adsorbed, the oil may be adsorbed only on the outer surface of the oil-sorbent 500, but the oil may not be adsorbed inside the oil-sorbent 500. In the oil-sorbent 500 according to Comparative Example, unlike the oil-sorbent according to the inventive concept, even when the thickness of the hydrophilic structure 510 is increased, an oil adsorption capacity may not increase.

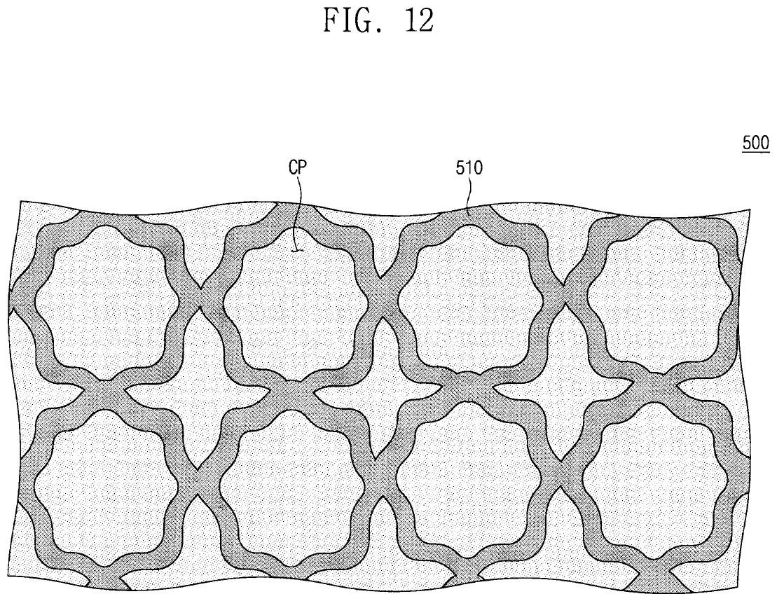

FIG. 13 is a conceptual view illustrating a process in which an oil-sorbent according to some Comparative Examples adsorbs oil.

Referring to FIG. 13, an oil-sorbent 600 according to some Comparative Examples may include a hydrophobic structure 610. The hydrophobic structure 610 may include a plurality of micro pores MP. The micro pores MP may have an average diameter W2 of about 1 mm or less. A water film may not be formed on a surface of the hydrophobic structure 610, and additionally, the hydrophobic structure 610 may have a strong adhesion with oil 300C. Therefore, the oil adsorbed in the oil-sorbent 600 may be adsorbed only on an outer surface of the oil-sorbent 600, but may not move up to the inside of the oil-sorbent 600. Therefore, even when the oil-sorbent becomes thicker, an oil adsorption capacity may not change. In addition, due to the strong adhesion between the hydrophobic structure and oil 300C, it may be difficult to desorb oil.

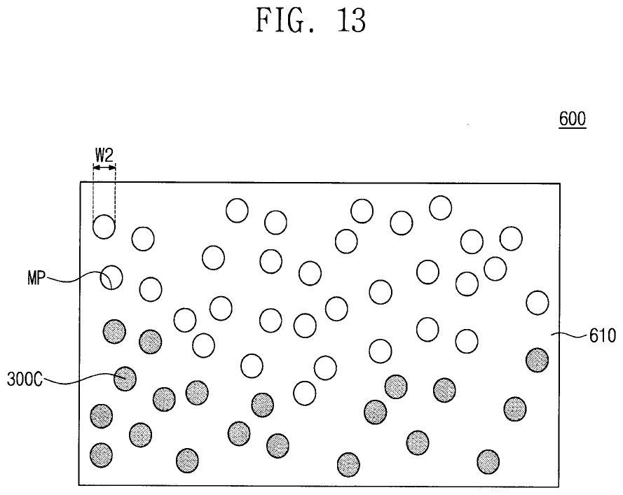

FIG. 14 is a conceptual view illustrating a process in which an oil-sorbent according to some Comparative Examples adsorbs oil.

Referring to FIG. 14, an oil-sorbent 700 according to some Comparative Examples may include a hydrophilic structure 710 having a plurality of micro pores MP. The micro pores MP may have an average diameter W2 of about 1 mm or less. In the hydrophilic structure 710, a water film 200C may occupy most of spaces in a micro pore MP, and thus there may be less space for oil to penetrate the micro pore MP and an oil adsorption capacity may be small.

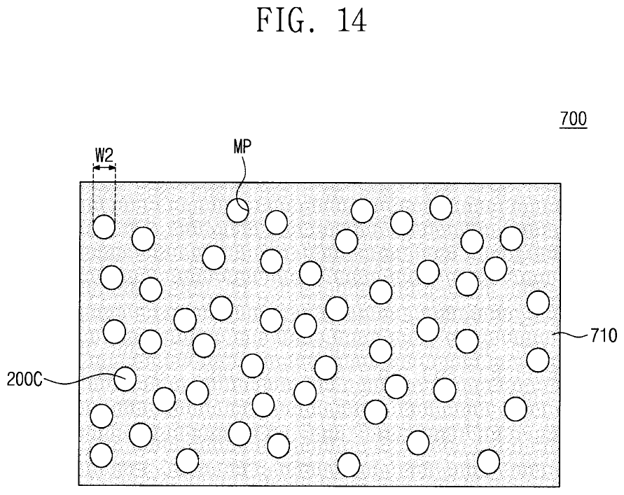

FIG. 15 is a graph showing a weight per unit area of oil obtained after adsorption and desorption of oil with oil-sorbents according to Examples and Comparative Examples, in which the oil-sorbent each has a different material and pore size.

An oil-sorbent according to Comparative Example A is composed of a hydrophobic structure having micrometer-scale micro pores. An oil-sorbent according to Comparative Example B contains a hydrophilic structure having micrometer-scale micro pores. Oil-sorbents according to Examples A through D respectively include hydrophilic structures having macro pores the porosities of which are gradually increased. The oil-sorbents according to Comparative Example B, and Examples A through D all employed the same material, except for a variation in pore size.

Referring to FIG. 15, the oil-sorbents according to Comparative Examples A and B showed little oil desorption. About 50 mg or more of oil per cm 2 was desorbed from the oil-sorbents according to Examples A through D. Additionally, as the porosity increased, an amount of desorbed oil also increased.

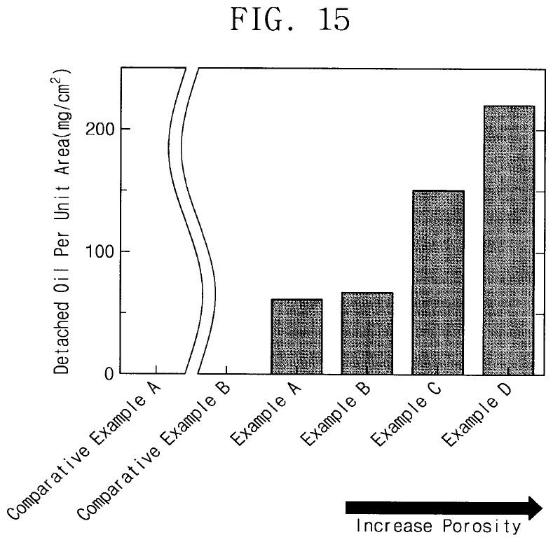

FIG. 16 is a graph showing measurement results of a weight of oil per unit area obtained after oil adsorption and desorption according to Examples, in which oil-sorbents have different thicknesses.

Referring to FIG. 16, as the thickness of the oil-sorbent was increased to about 5 mm, about 10 mm, and, about 20 mm, the amount of desorbed oil was increased. From this result, it is confirmed that the adsorption amount of oil was also increased correspondingly as the thickness of the oil-sorbent was increased, and the oil was adsorbed not only on the outer surface but also on the interior surface.

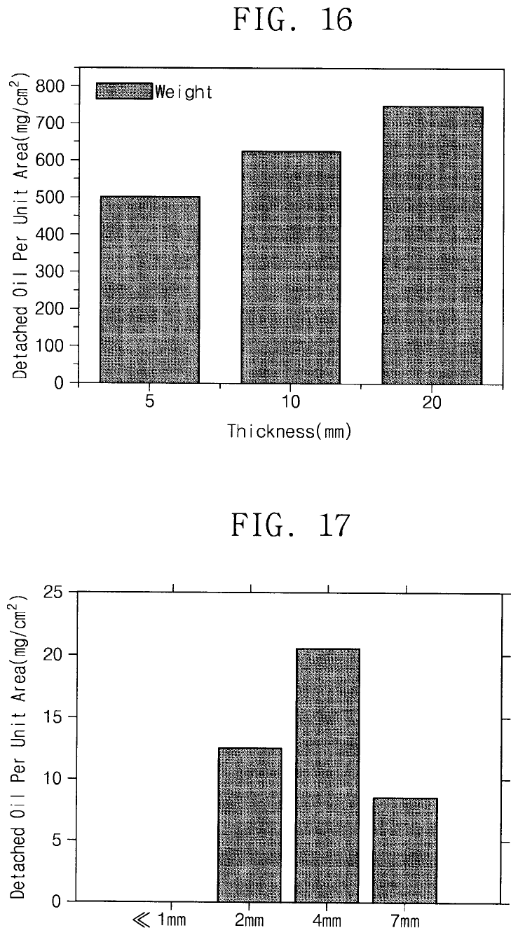

FIG. 17 is a graph showing a weight per unit area of oil obtained after adsorption and desorption of oil with oil-sorbents according to Examples, in which the oil-sorbents have different pore sizes.

Referring to FIG. 17, when a macro pore size is smaller than 1 mm, oil desorption was hardly performed. It may be seen that oil is well desorbed when the macro pore size is between about 2 mm to about 7 mm.

An oil-sorbent according to the inventive concept may include a hydrophilic structure containing a plurality of macro pores. The macro pores may have an average diameter of about 2 mm. In the hydrophilic substructure, a water film that fills a part of an inside of the macro pores may be formed first in the process of adsorbing oil on water. The water film may prevent oil from strongly adhering to the hydrophilic structure when the oil penetrates the macro pores.

In addition, while preventing oil from being leaked out during movement of the oil-sorbent which has adsorbed the oil, the macro pore having a millimeter-scale diameter allow the oil to be easily released from the oil-sorbent in an oil desorption process after movement.

That is, an oil-sorbent according to the inventive concept may include a hydrophilic structure, the hydrophilic structure may include a plurality of macro pores, and thus the oil-sorbent may have excellent oil adsorption and oil desorption abilities.

### Example 1-1

Formation of Hydrophilic Nano-substructure: Formation of Nano-Substructure on Surface of Hydrophobic structure.

At a vacuum level of about 10⁻⁴ mmHg or less, about 30 sccm of oxygen (O₂) gas was injected, and about 30 W of power was applied. A hydrophobic structure (for example, a macro porous aluminum foam, a macro porous hydrophobic polymer foam) was irradiated with ion beams using an ion beam sputter. As a result, a surface of the hydrophobic structure was surface-modified into a hydrophilic nano-substructure.

### Example 1-2

Formation of Hydrophilic Nano-Substructure: Formation of Nano-Substructure on Surface of Hydrophobic Structure

TiO₂ nanoparticles (an average particle diameter of about 30 nm) and a macro porous aluminum foam (an aluminum plate with a purity of about 99.9% and a thickness of about 0.3 mm) were put into boiling water. The resultant was maintained for about 10 minutes and the macro porous aluminum foam was then removed from the solution. As a result, a nano-substructure having hydrophilicity was formed on a surface of the porous aluminum foam.

### Example 2-1

Formation of Hydrophilic Coating Layer

About 0.01 M of tris buffer with pH 8.5 was prepared. Specifically, about 4.829 g of Trizma® hydrochloride and about 8.402 g of Trizma® base were mixed to prepare about 1 L of tris buffer. The tris buffer was added to ethanol (EtOH) to prepare a solution. About 4 mg/ml of dopamine and about 1 mM of NaIO₄ were added to the solution and mixed by stirring the solution, etc.

Then, the nano-substructure according to Example 1-1 was put into the solution and was coated for about 6 hours. After being coated, a washing process was performed. As a result, a hydrophilic coating layer was formed on the nano-substructure, and thereby the obtained nano-substructure has higher hydrophilicity than the nano-substructure according to Example 1-1

### Example 2-2

Formation of Hydrophilic Coating Layer

A polyvinyl alcohol (PVA) solution with a concentration of about 50 ppm to about 10000 ppm was prepared. At least one salt of NaCl, LiCl, KCl or MgCl₂ was added to the PVA solution. A hydrophobic structure to be coated was immersed in the PVA solution and was coated for about 30 seconds through about 60 minutes. At a temperature of about 15° C. through 90° C., the hydrophobic structure was immersed in glutaric anhydride or in a maleic aldehyde solution.

### Example 3-1

Formation of Macro Pore

One kind of polyol and one kind of isocyanate (mainly, toluene diisocyanate was used) were placed in the slabstock foam manufacturing process line to prepare a foam. A large cell foam was made in an unopened state, and then the cell was opened in a film forming process to thereby secure air permeability.

### Example 3-2

Formation of Macro Pore

In a manufacturing process of soft slabstock form, the molecular weight, number of functional groups, crosslinking density, heat of reaction, and catalyst balance of a foaming additive were adjusted. As the foaming additive, polyether polyol, methylene diphenyl diisocyanate, and typical foaming additives were used.

An oil-sorbent according to the inventive concept may include a hydrophilic structure containing a plurality of macro pores. The macro pores may have an average diameter of about 2 mm and more and the hydrophilic structure may have a porosity of about 70% or more.

In a hydrophilic structure, first, a water film that fills a part of the inside of the macro pores may be formed in a process of adsorbing oil on water. The water film may prevent oil from strongly adhering to the hydrophilic structure when oil is introduced into the macro pores.

In addition, while preventing oil from being leaked out during movement of the oil-sorbent which has adsorbed the oil, the macro pore having a millimeter-scale diameter allow the oil to be easily released from the oil-sorbent in an oil desorption process after movement.

That is, since an oil-sorbent according to the inventive concept includes a hydrophilic structure, and the hydrophilic structure includes a plurality of macro pores, the oil-sorbent may have excellent oil adsorption and oil desorption abilities.

Although the embodiments of the inventive concept have been described, it is understood that the inventive concept should not be limited to these embodiments but various changes and modifications can be made by one ordinary skilled in the art within the spirit and scope of the inventive concept as hereinafter claimed. Therefore, it should be understood that the embodiments described above are exemplarily in all respects and not limited thereto.

What is claimed is:

1. An oil-sorbent comprising a hydrophilic structure,
wherein the hydrophilic structure includes a plurality of macro pores, and the macro pores have an average diameter of about 2 mm and more.

2. The oil-sorbent of claim 1, wherein a surface of the hydrophilic structure has hydrophilicity.

3. The oil-sorbent of claim 1, wherein the hydrophilic structure further comprises a hydrophilic nano-substructure provided on the surface.

4. The oil-sorbent of claim 1, wherein the hydrophilic structure has a water contact angle of greater than about 0° and less than about 40°.

5. The oil-sorbent of claim 1, wherein the hydrophilic structure comprises:
a hydrophobic structure containing the macro pores; and
hydrophilic nano-substructures on the hydrophobic structure.

6. The oil-sorbent of claim 5, wherein each of the hydrophilic nano-substructures has a shape protruding from the surface of the hydrophobic structure, and
the hydrophilic nano-substructures are spaced apart from each other.

7. The oil-sorbent of claim 5,
wherein the hydrophobic structure includes a first metal, and
the hydrophilic nano-substructures each include an oxide of a second metal different from the first metal.

8. The oil-sorbent of claim 7, wherein the first metal includes aluminum, and the second metal oxide includes titanium dioxide.

9. The oil-sorbent of claim 1, wherein the hydrophilic structure comprises:
a hydrophobic structure containing the macro pores; and
a hydrophilic coating layer on the hydrophobic structure.

10. The oil-sorbent of claim 9, wherein the hydrophilic coating layer has a smaller thickness than the hydrophobic structure.

11. The oil-sorbent of claim 9, wherein the hydrophilic coating layer comprises a dopamine substance.

12. The oil-sorbent of claim 9, wherein the hydrophilic coating layer comprises at least one of polyvinyl alcohol (PVA), polyallylamine hydrochloride, or mixtures thereof.

13. The oil-sorbent of claim 9, wherein the hydrophobic structure comprises polyurethane foam.

14. The oil-sorbent of claim 1, wherein the hydrophilic structure further comprises s a floating body disposed therein.

15. The oil-sorbent of claim 14, wherein the floating body comprises air or hydrophobic material.

16. An oil-sorbent comprising a hydrophilic structure including a plurality of macro pores,
wherein the hydrophilic structure has an open-porous structure and has a porosity of at least 70%.

17. The oil-sorbent of claim 16, wherein the macro pores have an average diameter of about 2 mm to about 7 mm.

18. The oil-sorbent of claim 16, wherein the hydrophilic structure comprises at least one of dopamine, titanium dioxide, polyvinyl alcohol (PVA), or polyallylamine hydrochloride.

19. The oil-sorbent of claim 16, wherein the hydrophilic structure comprises:
a hydrophobic structure containing the macro pores; and
a hydrophilic coating layer covering a surface of the hydrophobic structure.

20. The oil-sorbent of claim 19, wherein the hydrophilic structure further comprises hydrophilic nano-substructures between the hydrophobic structure and the hydrophilic coating layer.
